(19) United States
(12) Patent Application Publication
(10) Pub. No.: US 2026/0127449 A1
(43) Pub. Date: May 7, 2026

(54) METHOD, ELECTRONIC DEVICE, AND STORAGE MEDIUM FOR GENERATING DYNAMIC KNOWLEDGE GRAPH

(71) Applicant: Intelligent Fusion Technology, Inc., Germantown, MD (US)

(72) Inventors: Xin TIAN, Germantown, MD (US); Genshe CHEN, Germantown, MD (US)

(21) Appl. No.: 18/935,372

(22) Filed: Nov. 1, 2024

(51) Int. Cl. G06N 5/022

(52) U.S. Cl. CPC G06N 5/022

(57) ABSTRACT

The present disclosure provides a dynamic knowledge graph generation method. The method includes providing a plurality of second-team asset nodes; arranging a plurality of first-team offensive instrument site nodes and a plurality of second-team defensive instrument site nodes; arranging a plurality of first-team offensive instrument nodes and a plurality of second-team defensive instrument nodes; arranging a plurality of first-team deployment nodes and a plurality of second-team deployment nodes; and providing a plurality of engagement nodes. A relationship from a site node to a deployment node is configured as “HOST”; a relationship from an instrument node to a deployment node is configured as “JOIN”; a relationship from a second-team asset node to an engagement node is configured as “TARGET”; a relationship from a second-team deployment node to the engagement node is configured as “DEFEND”; and a relationship from a first-team deployment node to the engagement node is configured as “OFFEND”.

### GOVERNMENT RIGHTS

The present disclosure was made with Government support under Contracts No. FA2384-23-P-0007, awarded by the United States Air Force. The U.S. Government has certain rights in the present disclosure.

### FIELD OF THE DISCLOSURE

The present disclosure generally relates to the field of machine learning technology and, more particularly, relates to a method, an electronic device, and a storage medium for generating a dynamic knowledge graph.

### BACKGROUND

Remarkable success of algorithm innovations in information processing and extraction has powered numerous large-scale applications in a variety of domains based on machine-friendly knowledge-graph (KG) representation. Examples may include DBpedia, Yet Another Great Ontology YAGO2, Freebase, Wikidata, and Google KG. A KG may represent information as entities and corresponding relations and may explicitly model interconnections between content itself as well as external knowledge sources. Knowledge-Graph-Data-Base (KGDB) is basic building block of various state-of-the-art data-driven cognitive systems. In KGDB, the existences of facts may be represented as subject-predicate-object (SPO) triples following standard World Wide Web Consortium (W3C) Resource Description Framework (RDF). The RDF symbolic representation, coupled with advanced pattern and relational learning methods, may provide a solid foundation to facilitate storing, exchanging, and visualizing knowledge. Likewise, there is supporting efficient inference for situation awareness and predictive analytics. For learning behavior of Second-team units in intelligence, surveillance, and reconnaissance ISR, conventional static KGs may need to be augmented into Temporal Knowledge Graphs (TKGs) where events/facts occur, recur, and evolve over time in graphs. This disclosure presents the design and generation of a dynamic knowledge graph (DKG) for the modeling and analysis of scenarios with two/multiple opposing teams. The DKG is able to effectively model the teams'asset allocation and the interactions between the teams, and facilities situational awareness and decision makings in the scenarios. However, most existing knowledge graphs are static which are not suitable for modeling or representing knowledge in dynamically evolving scenarios.

### BRIEF SUMMARY OF THE DISCLOSURE

One aspect of the present disclosure provides a method for generating a dynamic knowledge graph, applied to an instrument deployment scenario including a first team and a second team, where the first team includes an offensive participant, and the second team includes a defensive participant. The method includes providing a plurality of second-team asset nodes; arranging a plurality of site nodes, including a plurality of first-team offensive instrument site nodes and a plurality of second-team defensive instrument site nodes; arranging a plurality of instrument nodes, including a plurality of first-team offensive instrument nodes and a plurality of second-team defensive instrument nodes; arranging a plurality of deployment nodes, including a plurality of first-team deployment nodes and a plurality of second-team deployment nodes, where a first-team deployment node is configured to represent deployment of a first-team offensive instrument to a first-team offensive instrument site; and a second-team deployment node is configured to represent deployment of a second-team defensive instrument to a second-team defensive instrument site; and providing a plurality of engagement nodes. A relationship from a first-team offensive instrument site node to a first-team deployment node or from a second-team defensive instrument site node to a second-team deployment node is configured as “HOST”; a relationship from a first-team offensive instrument node to the first-team deployment node or from a second-team defensive instrument node to the second-team deployment node is configured as “JOIN”; a relationship from a second-team asset node to an engagement node is configured as “TARGET”; a relationship from the second-team deployment node to the engagement node is configured as “DEFEND”; a relationship from the first-team deployment node to the engagement node is configured as “OFFEND”; and the dynamic knowledge graph is configured for modeling and analysis of behaviors and interactions of opposing teams including the first team and the second team.

Another aspect of the present disclosure provides an electronic device. The electronic device includes a memory, configured to store program instructions for performing a method for generating a dynamic knowledge graph, applied to an instrument deployment scenario including a first team and a second team, where the first team includes an offensive participant, and the second team includes a defensive participant; and a processor, coupled with the memory and, when executing the program instructions, configured for: providing a plurality of second-team asset nodes; arranging a plurality of site nodes, including a plurality of first-team offensive instrument site nodes and a plurality of second-team defensive instrument site nodes; arranging a plurality of instrument nodes, including a plurality of first-team offensive instrument nodes and a plurality of second-team defensive instrument nodes; arranging a plurality of deployment nodes, including a plurality of first-team deployment nodes and a plurality of second-team deployment nodes, where a first-team deployment node is configured to represent deployment of a first-team offensive instrument to a first-team offensive instrument site; and a second-team deployment node is configured to represent deployment of a second-team defensive instrument to a second-team defensive instrument site; and providing a plurality of engagement nodes. A relationship from a first-team offensive instrument site node to a first-team deployment node or from a second-team defensive instrument site node to a second-team deployment node is configured as “HOST”; a relationship from a first-team offensive instrument node to the first-team deployment node or from a second-team defensive instrument node to the second-team deployment node is configured as “JOIN”; a relationship from a second-team asset node to an engagement node is configured as “TARGET”; a relationship from the second-team deployment node to the engagement node is configured as “DEFEND”; a relationship from the first-team deployment node to the engagement node is configured as “OFFEND”; and the dynamic knowledge graph is configured for modeling and analysis of behaviors and interactions of opposing teams including the first team and the second team.

Another aspect of the present disclosure provides a non-transitory computer-readable storage medium, containing program instructions for, when being executed by a processor, performing a method for generating a dynamic knowledge graph, applied to an instrument deployment scenario including a first team and a second team, where the first team includes an offensive participant, and the second team includes a defensive participant. The method includes providing a plurality of second-team asset nodes; arranging a plurality of site nodes, including a plurality of first-team offensive instrument site nodes and a plurality of second-team defensive instrument site nodes; arranging a plurality of instrument nodes, including a plurality of first-team offensive instrument nodes and a plurality of second-team defensive instrument nodes; arranging a plurality of deployment nodes, including a plurality of first-team deployment nodes and a plurality of second-team deployment nodes, where a first-team deployment node is configured to represent deployment of a first-team offensive instrument to a first-team offensive instrument site; and a second-team deployment node is configured to represent deployment of a second-team defensive instrument to a second-team defensive instrument site; and providing a plurality of engagement nodes. A relationship from a first-team offensive instrument site node to a first-team deployment node or from a second-team defensive instrument site node to a second-team deployment node is configured as “HOST”; a relationship from a first-team offensive instrument node to the first-team deployment node or from a second-team defensive instrument node to the second-team deployment node is configured as “JOIN”; a relationship from a second-team asset node to an engagement node is configured as “TARGET”; a relationship from the second-team deployment node to the engagement node is configured as “DEFEND”; a relationship from the first-team deployment node to the engagement node is configured as “OFFEND”; and the dynamic knowledge graph is configured for modeling and analysis of behaviors and interactions of opposing teams including the first team and the second team.

Other aspects of the present disclosure may be understood by those skilled in the art in light of the description, the claims, and the drawings of the present disclosure.

### BRIEF DESCRIPTION OF THE DRAWINGS

The accompanying drawings, which are incorporated into a part of the specification, illustrate embodiments of the present disclosure and together with the description to explain the principles of the present disclosure.

FIG. 1 depicts an exemplary method for generating a dynamic knowledge graph according to various disclosed embodiments of the present disclosure.

FIG. 2 depicts an exemplary mobile defensive instrument scenario between a first team and a second team on a 2D (dimensional) map according to various disclosed embodiments of the present disclosure.

FIG. 3 depicts a schematic of exemplary attack-defense engagement between a first-team offensive instrument and a second-team defensive instrument according to various disclosed embodiments of the present disclosure.

FIG. 4 depicts a schematic of exemplary attack-defense engagement score evaluation according to various disclosed embodiments of the present disclosure.

FIG. 5 depicts an exemplary schematic of simulated first-team surveillance on second team defensive instrument launch sites with surveillance vehicles according to various disclosed embodiments of the present disclosure.

FIG. 6 depicts an exemplary schematic of entities and corresponding relationships in a knowledge graph for a second-team defensive instrument deployment problem according to various disclosed embodiments of the present disclosure.

FIG. 7 depicts a screenshot of an exemplary full knowledge graph for a second-team defensive instrument deployment scenario according to various disclosed embodiments of the present disclosure.

FIG. 8 depicts a screenshot of an exemplary generated knowledge graph from query results according to various disclosed embodiments of the present disclosure.

FIG. 9 depicts a screenshot of another exemplary generated knowledge graph from query results according to various disclosed embodiments of the present disclosure.

FIG. 10 depicts an exemplary graphical user interface (GUI)) for queries with dynamic knowledge graphs according to various disclosed embodiments of the present disclosure.

FIG. 11 depicts a screenshot of an exemplary generated knowledge graph from first query results according to various disclosed embodiments of the present disclosure.

FIG. 12 depicts a screenshot of an exemplary generated knowledge graph from second query results according to various disclosed embodiments of the present disclosure.

FIG. 13 depicts a screenshot of an exemplary generated knowledge graph from third query results according to various disclosed embodiments of the present disclosure.

FIG. 14 depicts a screenshot of an exemplary generated knowledge graph from fourth query results according to various disclosed embodiments of the present disclosure.

FIG. 15 depicts an exemplary extended knowledge graph with deployment transition according to various disclosed embodiments of the present disclosure.

### DETAILED DESCRIPTION

References may be made in detail to exemplary embodiments of the disclosure, which may be illustrated in the accompanying drawings. Wherever possible, same reference numbers may be used throughout the accompanying drawings to refer to same or similar parts.

According to various embodiments of the present disclosure, a method, an electronic device, and a storage medium for generating a dynamic knowledge graph, applied to an instrument deployment scenario including a first team and a second team are described hereinafter.

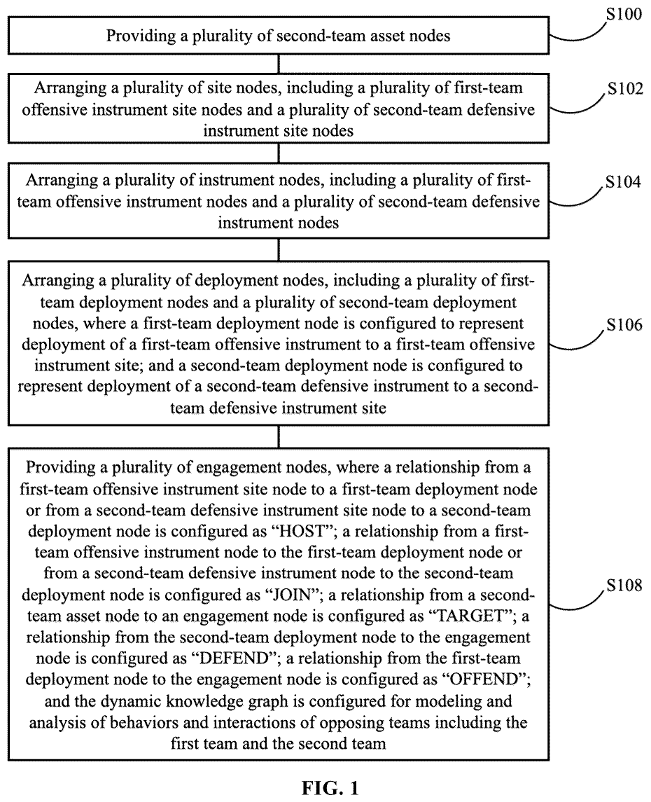

FIG. 1 depicts an exemplary method for generating a dynamic knowledge graph according to various disclosed embodiments of the present disclosure. The method is applied to an instrument deployment scenario including a first team and a second team, where the first team includes an offensive participant, and the second team includes a defensive participant. Referring to FIG. 1, the method for generating the dynamic knowledge graph may include following exemplary steps.

In S100, a plurality of second-team asset nodes is provided.

In S102, a plurality of site nodes, including a plurality of first-team offensive instrument site nodes and a plurality of second-team defensive instrument site nodes, are arranged.

In S104, a plurality of instrument nodes (or instrument type nodes), including a plurality of first-team offensive instrument nodes (or offensive instrument type nodes) and a plurality of second-team defensive instrument nodes (or defensive instrument type nodes), are arranged.

In S106, a plurality of deployment nodes, including a plurality of first-team deployment nodes and a plurality of second-team deployment nodes, are arranged, where a first-team deployment node is configured to represent deployment of a first-team offensive instrument to a first-team offensive instrument site; and a second-team deployment node is configured to represent deployment of a second-team defensive instrument to a second-team defensive instrument site.

In S108, a plurality of engagement nodes is provided, where a relationship from a first-team offensive instrument site node to a first-team deployment node or from a second-team defensive instrument site node to a second-team deployment node is configured as “HOST”; a relationship from a first-team offensive instrument node to the first-team deployment node or from a second-team defensive instrument node to the second-team deployment node is configured as “JOIN”; a relationship from a second-team asset node to an engagement node is configured as “TARGET”; a relationship from the second-team deployment node to the engagement node is configured as “DEFEND”; a relationship from the first-team deployment node to the engagement node is configured as “OFFEND”; and the dynamic knowledge graph is configured for modeling and analysis of behaviors and interactions of opposing teams including the first team and the second team.

In one embodiment, the method further includes arranging a plurality of surveillance vehicles, including a plurality of second-team surveillance vehicles and/or a plurality of first-team surveillance vehicles

In one embodiment, a relationship from a first-team surveillance vehicle to a second-team defensive instrument site node is configured as “OBSERVE”

In one embodiment, a relationship from a second-team surveillance vehicle to a first-team offensive instrument site node is configured as “OBSERVE”.

In one embodiment, the method further includes arranging a plurality of transition nodes, including a plurality of second-team transition nodes and a plurality of first-team transition nodes.

In one embodiment, a relationship from a second-team deployment node to a second-team transition node is configured as “FROM”; and a relationship from another second-team deployment node to the second-team transition node is configured as “TO”.

In one embodiment, an engagement score is calculated as a property of an engagement node according to an evaluated outcome of a corresponding engagement.

In one embodiment, a plurality of queries is performed on the dynamic knowledge graph to generate a plurality of query results.

In one embodiment, the plurality of query results is configured to evaluate assets and sites.

In one embodiment, modeling and analysis of the behaviors and interactions of the opposing teams is configured to support a situational awareness process and a decision making process.

To model and dynamically propagate emotional state of an entity as well as detect changes and predict anomalous behavior, Dynamic Knowledge Graph (DKG), as a critical element of reasoning engine, is provided in the present disclosure. The DKG may provide a desirable representational manner that captures structural and temporal constraints and dependencies. The DKG may lay a solid foundation for reasoning, inference, and data fusion. However, the DKG may be an unexplored area for surveillance applications. The first such endeavor may be YAGO2, a spatially and temporally enhanced KGDB from original YAGO knowledge base. YAGO2 may be designed with the goal of integrating entity-relationship-oriented facts with spatial and temporal dimensions. YAGO2, an extension of the YAGO knowledge base, may be automatically built from Wikipedia and other sources, where entities, facts, and events may be anchored in both time and space. YAGO2 may employ a new representational model, called SPOTL (SPO+Time+Location), which may co-exist with SPO triples, but provide a significantly convenient manner of browsing and querying the knowledge base.

In the present disclosure, the dynamic knowledge graph (DKG) is implemented for modeling and analysis of behaviors and interactions of opposing forces (e.g., a first team and a second team). Each team may have a set of assets which can be deployed to available sites. Deployed assets of the teams may interact with one another through engagements. As a result, the knowledge graph may be designed to have various assets, sites, deployment and engagements as basic elements for modeling and analysis of the team behaviors. Exemplarily, in the present disclosure, a mobile defensive instrument scenario may be considered.

The present disclosure presents the design and generation of a dynamic knowledge graph (DKG) for the modeling and analysis of scenarios with two/multiple opposing teams. The DKG is able to effectively model the teams'asset allocation and the interactions between the teams, and facilities situational awareness and decision makings in the scenarios.

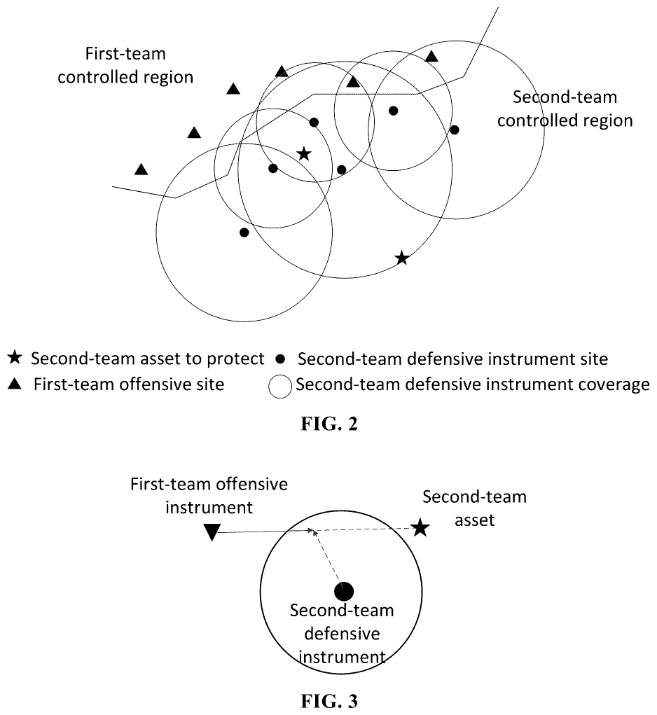

FIG. 2 depicts an exemplary mobile defensive instrument scenario between the first team and the second team on a 2D (dimensional) map according to various disclosed embodiments of the present disclosure. The second-team controlled region and the first-team controlled region may be separated by a black line. The black circles may be sites where the second-team mobile defensive instruments may be deployed. The black star may indicate assets or the second team that are protected by the second-team offensive instrument(s) against attacks from the first-team offensive instrument(s). The black circles may show the defense area of the second-team defensive instruments deployed at the second-team defensive instrument sites, which reflect different defense coverage by different second-team defensive instruments. The second-team defensive instrument may be a reactive system, which needs to consider possible attacks on the second-team asset. The black triangles may show possible sites for the first team to launch attacks on the second-team assets. The second-team defensive instruments may be deployed to intercept attacks from the first team on the protected assets.

According to various embodiments of the present disclosure, engagement and engagement score evaluation is described in detail hereinafter.

FIG. 3 depicts a schematic of exemplary attack-defense engagement between a first-team offensive instrument and a second-team defensive instrument according to various disclosed embodiments of the present disclosure. The first team may launch an offensive instrument from a site targeting a second-team asset, and a second-team may launch a defensive instrument from a site to intercept the defensive instrument. The result of the engagement may depend on factors including i) location of the first-team attack launch site, ii) location of the second-team asset (under attack), iii) location of the second-team defensive instrument site, iv) type and properties of the first-team offensive instrument (e.g., speed, flying height, radar cross section (RCS), or the like), and v) type and properties of the second-team defensive instrument (e.g., speed, range, or the like). Analyzing the second-team defensive instrument deployment may involve evaluating attack-defense (i.e., the first team-the second team) engagement score to assess the value of deploying the defensive instrument at a specific site for asset defense against a first-team attack launch site.

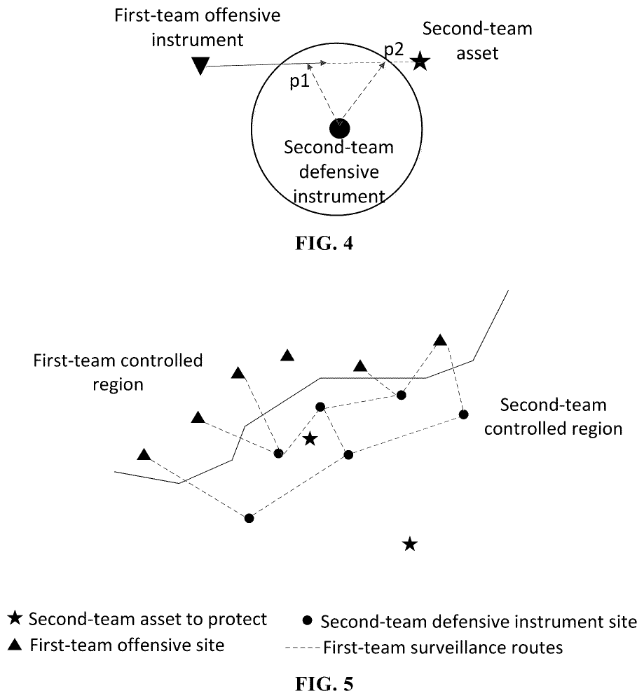

FIG. 4 depicts a schematic of exemplary attack-defense engagement score evaluation according to various disclosed embodiments of the present disclosure. Referring to FIG. 4, on the flight path of the first-team offensive instrument towards the target, the section between p1 and p2 may show the portion where the second-team defensive instrument can intercept the first-team offensive instrument, where point p1 is the earliest intercept point, and point p2 is the latest intercept point. Obviously, p1 and p2 may be within the range circle of the defensive instrument. The two intercept points may be evaluated based on the geometry information in the engagement scenario and the speed values of the attacking and defending instruments. The engagement score may be evaluated as the time difference between the earliest and the latest intercept point. It can be seen that, when the defensive instrument is faster, the engagement score may drop; and when the launch site of the defensive instrument is farther away from the attacking path, the engagement score may also drop. A more sophisticated evaluation of the engagement score may also include defensive instrument RCS, and flight height information, which may affect the success rate of the interception.

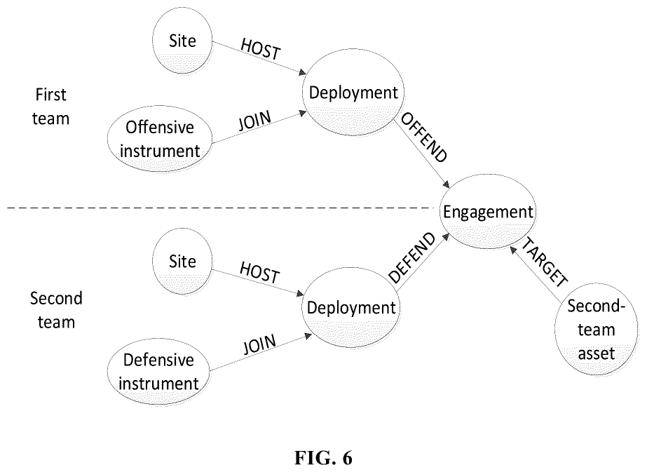

To take surveillance into account, the first team or second team may use surveillance assets (e.g., surveillance vehicles) to observe the sites of the other side. FIG. 5 depicts an exemplary schematic of simulated first-team surveillance on second team defensive instrument launch sites with surveillance vehicles according to various disclosed embodiments of the present disclosure. FIG. 5 illustrates the first team's surveillance vehicle routes with the dashed lines in a simulated scenario. When the surveillance vehicle fly pass the second-team defensive instrument site, surveillance data may be generated on the defensive instrument site, which may include the quantity of defensive instrument vehicles operating in the site, the types of the defensive instruments, available quantity of defensive instruments, and/or the like.

According to various embodiments of the present disclosure, the knowledge graph for scenario analysis is described in detail hereinafter.

Knowledge graphs are used to represent various entities and relationships among the entities. In the present disclosure, the knowledge graph has been developed for the modeling and analysis of the entities and optional events in the considered scenario.

FIG. 6 depicts an exemplary schematic of entities and corresponding relationships in the knowledge graph for the second-team defensive instrument deployment problem according to various disclosed embodiments of the present disclosure. The node type (or node) “first-team site” denotes the potential attack launching site of the first team (the first-team spatial asset) corresponding to the triangle in FIG. 2. The node type “first-team offensive instrument” denotes the offensive instrument of the first team (the first-team physical asset). The node type “first-team deployment” denotes deployment of the offensive instrument to the second-team site. The relationship from the “first-team site” node to the “first-team deployment” node may be defined as “HOST”. The relationship from the “first-team offensive instrument” node to the “first-team deployment” node may be defined as “JOIN”. The node type “second-team site” denotes the second-team defensive instrument site. The node type “second-team defensive instrument” denotes the second-team defensive instrument. The node type “second-team deployment” denotes the deployment of the second-team defensive instrument (the second-team physical asset) to the defensive instrument site (the second-team spatial asset). The relationship from the “second-team site” node to the “second-team deployment” node may be defined as “HOST”. The relationship from the “second-team defensive instrument” node to the “second-team deployment” node may be defined as “JOIN”. The node type “engagement” may be defined to represent a potential engagement, as illustrated in FIG. 3.

The “second-team asset” node may be defined for the second-team assets to protect (e.g., a base), and has a relationship with the “engagement” node as “TARGET”, which makes the “second-team asset” node to be the target of the engagement. The relationship from the “second-team deployment” node to the “engagement” node may be defined as “DEFEND”. The relationship from the “first-team deployment” node to the “engagement” node may be defined as “OFFEND”.

In some embodiments of the present disclosure, at the scenario considered, the first team may use the surveillance vehicles to conduct surveillance on the second-team's defensive instrument sites.

According to various embodiments of the present disclosure, queries with the knowledge graph is described in detail hereinafter.

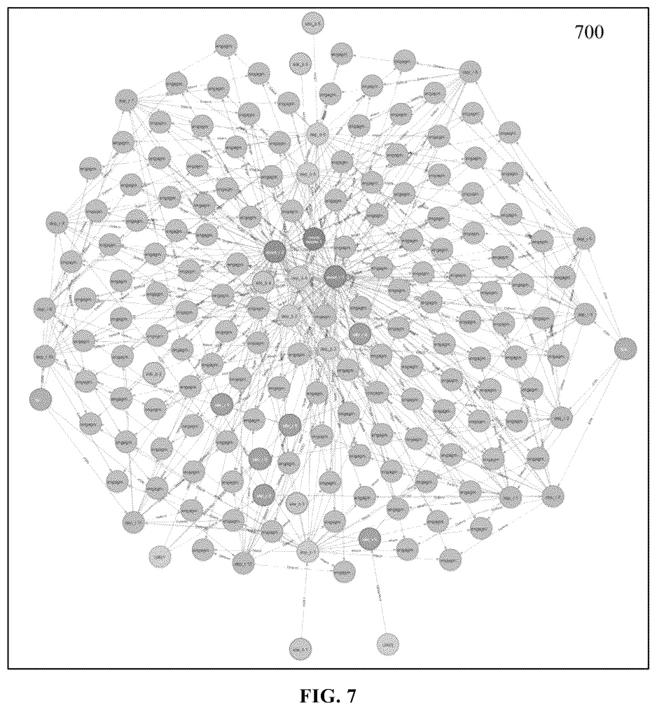

FIG. 7 depicts a screenshot of an exemplary full knowledge graph for the second-team defensive instrument deployment scenario according to various disclosed embodiments of the present disclosure. FIG. 7 illustrates a full knowledge graph screenshot 700 for the second-team defensive instrument deployment scenario. Referring to FIG. 7, the full knowledge graph for second-team defensive instrument deployment scenario may be built with Neo4j (software name) graph database.

Queries may be made using Neo4j's Cypher query language based on the full knowledge graph for the analysis of the scenario. The following query may identify engagements on one of the targets which are effective for the first-team offensive instrument defense with the engagement score higher than 90.

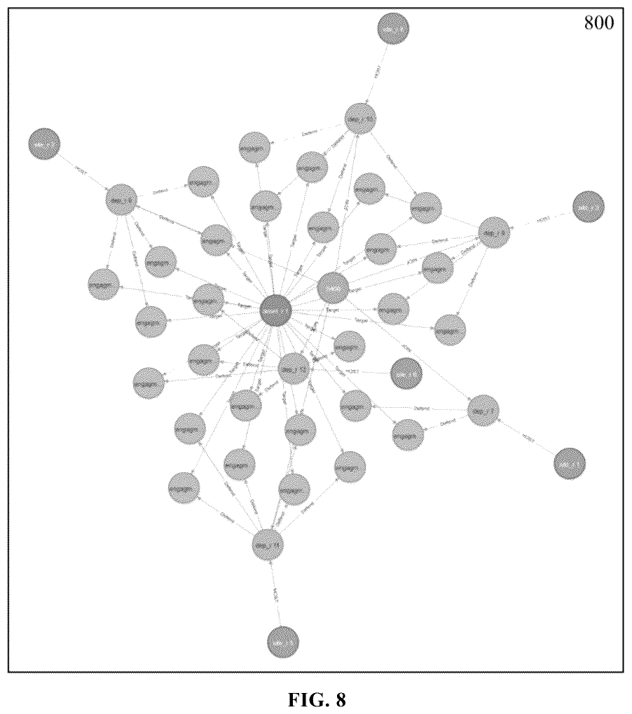

FIG. 8 depicts a screenshot of an exemplary generated knowledge graph from query results according to various disclosed embodiments of the present disclosure. FIG. 8 illustrates a generated knowledge graph screenshot 800 of query results. Referring to FIG. 8, generated knowledge graph from query results may be shown for effective first-team defense engagement for the second-team asset with engagement score higher than 90.

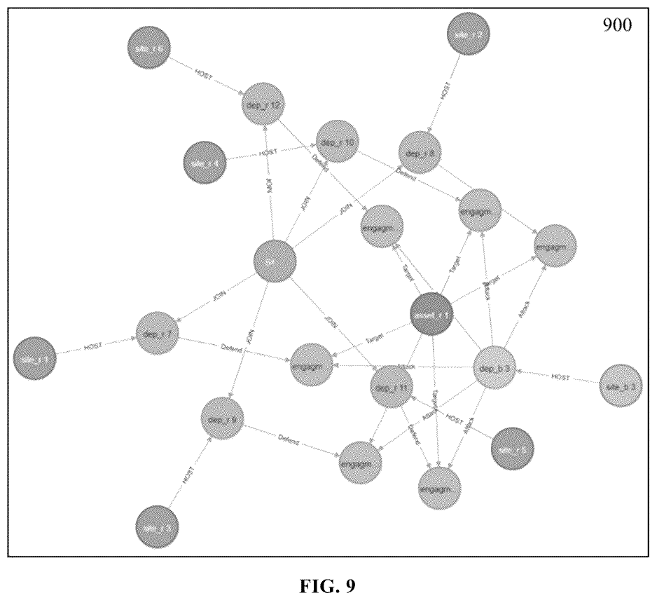

FIG. 9 depicts a screenshot of another exemplary generated knowledge graph from query results according to various disclosed embodiments of the present disclosure. FIG. 9 illustrates a generated knowledge graph screenshot 900 of query results. Referring to FIG. 9, the query result for effective first-team offensive instrument attacks launched from the first-team attacking site 3 with engagement scores over 90 may be shown. That is, resulting knowledge graph from the query may show all effective defense of first-team offensive instruments on attacks launched from the first-team attacking site 3.

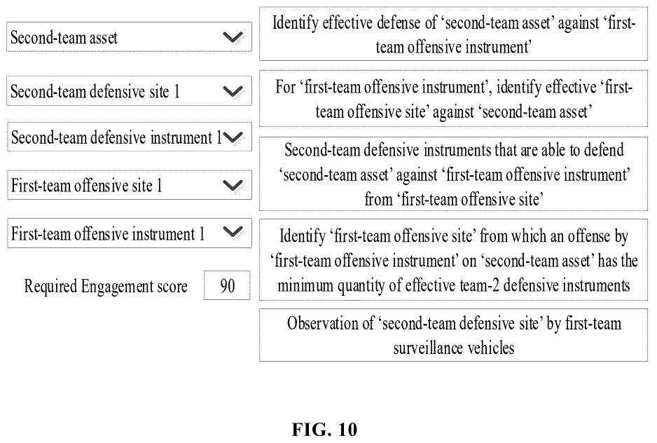

To allow more sophisticated analysis of the scenario, a python program has been developed. FIG. 10 depicts an exemplary graphical user interface (GUI)) for queries with dynamic knowledge graphs according to various disclosed embodiments of the present disclosure. As shown in FIG. 10, the GUI of the python program for DKG query-based scenario analysis is configured. The left side of the GUI shows a plurality of lists that can be used to select various units involved in the mobile defensive instrument scenario. The ‘Second-team asset’ list may allow the section of second team asset of interest for the query. The ‘Second-team defensive site’ list may allow the selection of a defensive instrument site of the second team for the query. The ‘Second-team defensive instrument’ list may allow the selection of the type of defensive instrument for the query. The ‘First-team offensive site’ list may be a list of sites where attacks on second-team assets from the first team can be launched.

The right side of the GUI may have buttons of, for example, queries based on the DKG. The first query (the first query button) of “identify effective defense of ‘second-team asset’ against ‘first-team offensive instrument’ launched from ‘first-team offensive site’ with ‘required engagement score’” may perform the query with parameters selected from corresponding list of entities. The ‘required engagement score’ may be a threshold for required level of engagement score.

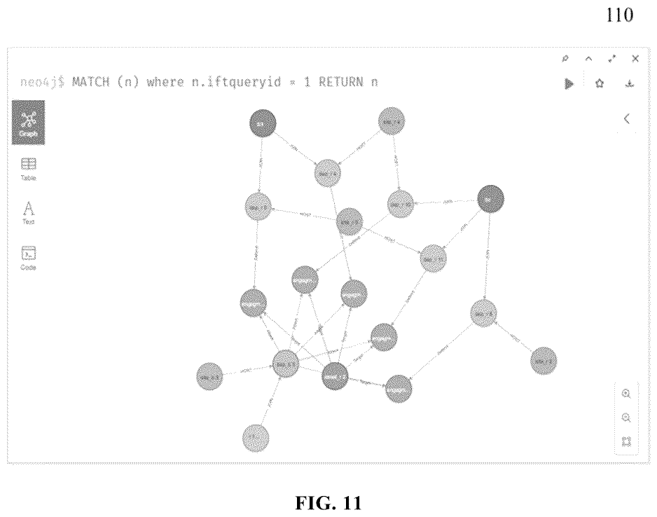

FIG. 11 depicts a screenshot of an exemplary generated knowledge graph from first query results according to various disclosed embodiments of the present disclosure. FIG. 11 illustrates a generated knowledge graph screenshot 110 of first query results. Referring to FIG. 11, the results of the first query as the knowledge graph may include qualified engagements, corresponding deployments, second-team defensive instrument sites, types of defensive instruments, first-team launch sites, types of first-team offensive instruments and/or any suitable entities, which may not be limited in embodiments of the present disclosure.

The second query (the second query button) may be “For ‘first-team offensive instrument’, identify effective ‘first-team offensive site’ against ‘second-team asset’”. Similarly, parameters of the query may be specified using the lists on the left side of the GUI. The second query may find the best first-team site for launching attacking on selected second-team asset, from which the attack may be hard to defend for the second-team defensive instrument. For the second query, the second-team defensive instrument may try to maximize the engagement score by selecting the best defensive instrument type and site against the first-team offensive instrument. The first-team side may try to minimize the engagement score by selecting the most advantage launch site. The second query may include multiple sub-queries with the DKG database, and the final decision may be based on the results from the sub-queries.

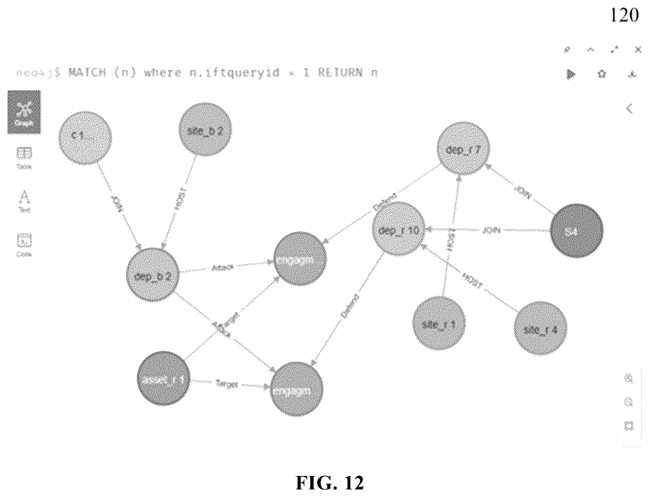

FIG. 12 depicts a screenshot of an exemplary generated knowledge graph from second query results according to various disclosed embodiments of the present disclosure. FIG. 12 illustrates a generated knowledge graph screenshot 120 of second query results. Referring to FIG. 12, the result identifying the most advantage first-team offensive instrument launch site may be visualized with Neo4j's graph visualization GUI. The graph may include all entities that are involved in the minmax solution of the deployment problem, which may be beneficial for analyzers to evaluate corresponding scenarios.

The third query (the third query button) may be “second-team defensive instruments that are able to defend ‘second-team asset’ against ‘first-team offensive instrument’ from ‘first-team offensive site’”. The third query may return the quantity of defensive instruments and the quantity of defensive instruments that are qualified for the defense.

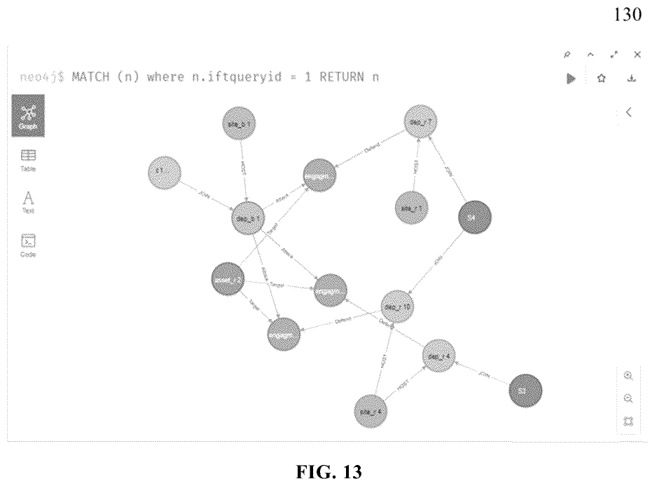

FIG. 13 depicts a screenshot of an exemplary generated knowledge graph from third query results according to various disclosed embodiments of the present disclosure. FIG. 13 illustrates a generated knowledge graph screenshot 130 of third query results. As shown in FIG. 13, the types of defensive instruments, defensive instrument sites and the engagements from the query result may be viewed as the knowledge graph; and locations of the sites and second-team asset involved may be shown on the scenario map.

The fourth query (the fourth query button) may be “identify first-team offensive site from which an offense by ‘first-team offensive instrument’ on ‘second-team asset’ has the minimum quantity of effective second-team defensive instruments”.

For each first-team launch site, the fourth query may return the quantity of second-team defensive instruments and the quantity of defensive instruments that can defend against the attack.

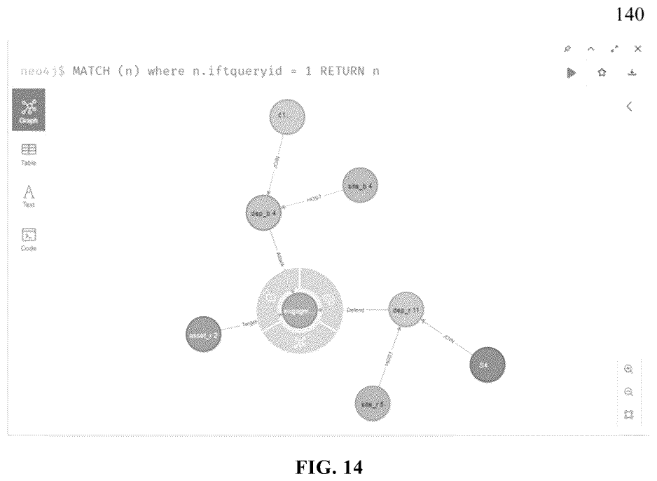

FIG. 14 depicts a screenshot of an exemplary generated knowledge graph from fourth query results according to various disclosed embodiments of the present disclosure. FIG. 14 illustrates a generated knowledge graph screenshot 140 of fourth query results. Referring to FIG. 14, the graph may show the first team deployment and engagements with the minimum quantity of defensive instruments.

As disclosed above, the knowledge graph may effectively integrate domain knowledge and surveillance data in complex battlefield scenarios to support situational awareness and mission planning. First-team surveillance gaps may introduce uncertainties of second-team defensive instrument deployment. The uncertainties may be modeled, and the impact on query results may be evaluated and used to prioritize the surveillance plan. The model of second-team mobile defensive instrument vehicle behaviors may be developed, which may account for factors including defensive instrument site safety, defensive instrument vehicle operation and maintenance needs to improve the prediction of second-team defensive instrument deployment.

To model the dynamics of the second-team and first-team interactions, transitions of the first team/second team deployments may be applied to the knowledge graph. A new type of entity, transition (i.e., transition of unit deployment) may be added to the knowledge graph. When a second-team or first-team unit moves from a site to a different site for a deployment change, a transition event may occur. Properties of a transition may include: (i) the transition time, (exemplarily, may correspond to the time for the unit to move from the starting site to the target site of the transition through a route) (ii) risk of the transition (exemplarily, may account for the probability of the unit being attacked during the transition and resulting unit loss) (iii) cost of the transition, and the like. The properties of the transition may derived from the domain knowledge.

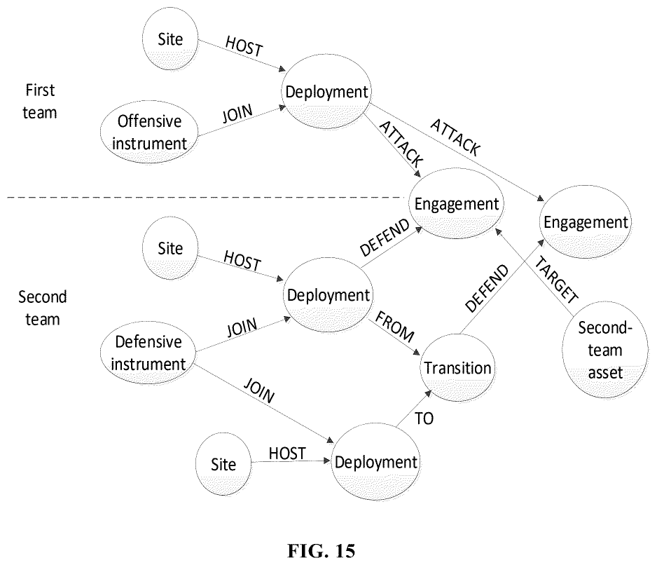

FIG. 15 depicts an exemplary extended knowledge graph with deployment transition according to various disclosed embodiments of the present disclosure. Referring to FIG. 15, the structure of the knowledge graph with the “transition” entity type may be added. A first-team/second-team transition entity may have relations from two first-team/second-team deployments. The relationship with one of the deployments may be defined as “FROM” indicating the initial source deployment, and the relationship with another deployment may be defined as “TO” indicating the target deployment of the transition. The transition may be attacked by a “deployment” of another force, which may be represented by an engagement node in the knowledge graph as illustrated in FIG. 15.

In the present disclosure, the dynamic knowledge graph (DKG) is implemented for modeling and analysis of behaviors and interactions of opposing forces (e.g., the first team and the second team). Each team may have a set of assets which can be deployed to available sites. Deployed assets of the teams may interact with one another through engagements. As a result, the knowledge graph may be designed to have various assets, sites, deployment and engagements as basic elements for modeling and analysis of the team behaviors.

Various embodiments of the present disclosure provide an electronic device. The electronic device includes a memory, configured to store program instructions for performing a method for generating a dynamic knowledge graph, applied to an instrument deployment scenario including a first team and a second team, where the first team includes an offensive participant, and the second team includes a defensive participant; and a processor, coupled with the memory and, when executing the program instructions, configured for: providing a plurality of second-team asset nodes; arranging a plurality of site nodes, including a plurality of first-team offensive instrument site nodes and a plurality of second-team defensive instrument site nodes; arranging a plurality of instrument nodes, including a plurality of first-team offensive instrument nodes and a plurality of second-team defensive instrument nodes; arranging a plurality of deployment nodes, including a plurality of first-team deployment nodes and a plurality of second-team deployment nodes, where a first-team deployment node is configured to represent deployment of a first-team offensive instrument to a first-team offensive instrument site; and a second-team deployment node is configured to represent deployment of a second-team defensive instrument to a second-team defensive instrument site; and providing a plurality of engagement nodes. A relationship from a first-team offensive instrument site node to a first-team deployment node or from a second-team defensive instrument site node to a second-team deployment node is configured as “HOST”; a relationship from a first-team offensive instrument node to the first-team deployment node or from a second-team defensive instrument node to the second-team deployment node is configured as “JOIN”; a relationship from a second-team asset node to an engagement node is configured as “TARGET”; a relationship from the second-team deployment node to the engagement node is configured as “DEFEND”; a relationship from the first-team deployment node to the engagement node is configured as “OFFEND”; and the dynamic knowledge graph is configured for modeling and analysis of behaviors and interactions of opposing teams including the first team and the second team.

Various embodiments of the present disclosure provide a non-transitory computer-readable storage medium, containing program instructions for, when being executed by a processor, performing a method for generating a dynamic knowledge graph, applied to an instrument deployment scenario including a first team and a second team, where the first team includes an offensive participant, and the second team includes a defensive participant. The method includes providing a plurality of second-team asset nodes; arranging a plurality of site nodes, including a plurality of first-team offensive instrument site nodes and a plurality of second-team defensive instrument site nodes; arranging a plurality of instrument nodes, including a plurality of first-team offensive instrument nodes and a plurality of second-team defensive instrument nodes; arranging a plurality of deployment nodes, including a plurality of first-team deployment nodes and a plurality of second-team deployment nodes, where a first-team deployment node is configured to represent deployment of a first-team offensive instrument to a first-team offensive instrument site; and a second-team deployment node is configured to represent deployment of a second-team defensive instrument to a second-team defensive instrument site; and providing a plurality of engagement nodes. A relationship from a first-team offensive instrument site node to a first-team deployment node or from a second-team defensive instrument site node to a second-team deployment node is configured as “HOST”; a relationship from a first-team offensive instrument node to the first-team deployment node or from a second-team defensive instrument node to the second-team deployment node is configured as “JOIN”; a relationship from a second-team asset node to an engagement node is configured as “TARGET”; a relationship from the second-team deployment node to the engagement node is configured as “DEFEND”; a relationship from the first-team deployment node to the engagement node is configured as “OFFEND”; and the dynamic knowledge graph is configured for modeling and analysis of behaviors and interactions of opposing teams including the first team and the second team.

Although some embodiments of the present disclosure have been described in detail through various embodiments, those skilled in the art should understand that above embodiments may be for illustration only and may not be intended to limit the scope of the present disclosure. Those skilled in the art should understood that modifications may be made to above embodiments without departing from the scope and spirit of the present disclosure. The scope of the present disclosure may be defined by the appended claims.

What is claimed is

1. A method for generating a dynamic knowledge graph, applied to an instrument deployment scenario including a first team and a second team, wherein the first team includes an offensive participant, and the second team includes a defensive participant, the method comprising:
providing a plurality of second-team asset nodes;
arranging a plurality of site nodes, including a plurality of first-team offensive instrument site nodes and a plurality of second-team defensive instrument site nodes;
arranging a plurality of instrument nodes, including a plurality of first-team offensive instrument nodes and a plurality of second-team defensive instrument nodes;
arranging a plurality of deployment nodes, including a plurality of first-team deployment nodes and a plurality of second-team deployment nodes, wherein a first-team deployment node is configured to represent deployment of a first-team offensive instrument to a first-team offensive instrument site; and a second-team deployment node is configured to represent deployment of a second-team defensive instrument to a second-team defensive instrument site; and
providing a plurality of engagement nodes, wherein:
a relationship from a first-team offensive instrument site node to a first-team deployment node or from a second-team defensive instrument site node to a second-team deployment node is configured as “HOST”; a relationship from a first-team offensive instrument node to the first-team deployment node or from a second-team defensive instrument node to the second-team deployment node is configured as “JOIN”; a relationship from a second-team asset node to an engagement node is configured as “TARGET”; a relationship from the second-team deployment node to the engagement node is configured as “DEFEND”; a relationship from the first-team deployment node to the engagement node is configured as “OFFEND”; and the dynamic knowledge graph is configured for modeling and analysis of behaviors and interactions of opposing teams including the first team and the second team.

2. The method according to claim 1, further including:
arranging a plurality of surveillance vehicles, including a plurality of second-team surveillance vehicles and/or a plurality of first-team surveillance vehicles.

3. The method according to claim 2, wherein:
a relationship from a first-team surveillance vehicle to a second-team defensive instrument site node is configured as “OBSERVE”.

4. The method according to claim 2, wherein:
a relationship from a second-team surveillance vehicle to a first-team offensive instrument site node is configured as “OBSERVE”.

5. The method according to claim 1, further including:
arranging a plurality of transition nodes, including a plurality of second-team transition nodes and a plurality of first-team transition nodes.

6. The method according to claim 5, wherein:
a relationship from a second-team deployment node to a second-team transition node is configured as “FROM”; and a relationship from another second-team deployment node to the second-team transition node is configured as “TO”.

7. The method according to claim 1, wherein:
an engagement score is calculated as a property of the engagement node according to an evaluated outcome of a corresponding engagement and configured for representing an engagement value to the first team and/or the second team.

8. The method according to claim 1, wherein:
a plurality of queries is performed on the dynamic knowledge graph to generate a plurality of query results.

9. The method according to claim 8, wherein:
the plurality of query results is configured to return corresponding assets, sites, and engagements according to criterions set by the plurality of queries.

10. The method according to claim 1, wherein:
modeling and analysis of the behaviors and interactions of the opposing teams is configured to support a situational awareness process and a decision making process.

11. An electronic device, comprising:
a memory, configured to store program instructions for performing a method for generating a dynamic knowledge graph, applied to an instrument deployment scenario including a first team and a second team, wherein the first team includes an offensive participant, and the second team includes a defensive participant; and
a processor, coupled with the memory and, when executing the program instructions, configured for:
providing a plurality of second-team asset nodes;
arranging a plurality of site nodes, including a plurality of first-team offensive instrument site nodes and a plurality of second-team defensive instrument site nodes;
arranging a plurality of instrument nodes, including a plurality of first-team offensive instrument nodes and a plurality of second-team defensive instrument nodes;
arranging a plurality of deployment nodes, including a plurality of first-team deployment nodes and a plurality of second-team deployment nodes, wherein a first-team deployment node is configured to represent deployment of a first-team offensive instrument to a first-team offensive instrument site; and a second-team deployment node is configured to represent deployment of a second-team defensive instrument to a second-team defensive instrument site; and
providing a plurality of engagement nodes, wherein:
a relationship from a first-team offensive instrument site node to a first-team deployment node or from a second-team defensive instrument site node to a second-team deployment node is configured as “HOST”; a relationship from a first-team offensive instrument node to the first-team deployment node or from a second-team defensive instrument node to the second-team deployment node is configured as “JOIN”; a relationship from a second-team asset node to an engagement node is configured as “TARGET”; a relationship from the second-team deployment node to the engagement node is configured as “DEFEND”; a relationship from the first-team deployment node to the engagement node is configured as “OFFEND”; and the dynamic knowledge graph is configured for modeling and analysis of behaviors and interactions of opposing teams including the first team and the second team.

12. The electronic device according to claim 11, wherein the processor is further configured to:
arrange a plurality of surveillance vehicles, including a plurality of second-team surveillance vehicles and/or a plurality of first-team surveillance vehicles.

13. The electronic device according to claim 12, wherein:
a relationship from a first-team surveillance vehicle to a second-team defensive instrument site node is configured as “OBSERVE”.

14. The electronic device according to claim 12, wherein:
a relationship from a second-team surveillance vehicle to a first-team offensive instrument site node is configured as “OBSERVE”.

15. The electronic device according to claim 11, wherein the processor is further configured to:
arrange a plurality of transition nodes, including a plurality of second-team transition nodes and a plurality of first-team transition nodes.

16. The electronic device according to claim 15, wherein:
a relationship from a second-team deployment node to a second-team transition node is configured as “FROM”; and a relationship from another second-team deployment node to the second-team transition node is configured as “TO”.

17. The electronic device according to claim 11, wherein:
an engagement score is calculated as a property of the engagement node according to an evaluated outcome of a corresponding engagement and configured for representing an engagement value to the first-team and/or the second-team.

18. The electronic device according to claim 11, wherein:
a plurality of queries is performed on the dynamic knowledge graph to generate a plurality of query results.

19. The electronic device according to claim 18, wherein:
the plurality of query results is configured to return corresponding assets, sites, and engagements according to criterions set by the plurality of queries.

20. A non-transitory computer-readable storage medium, containing program instructions for, when being executed by a processor, performing a method for generating a dynamic knowledge graph, applied to an instrument deployment scenario including a first team and a second team, wherein the first team includes an offensive participant, and the second team includes a defensive participant, the method comprising:
providing a plurality of second-team asset nodes;
arranging a plurality of site nodes, including a plurality of first-team offensive instrument site nodes and a plurality of second-team defensive instrument site nodes;
arranging a plurality of instrument nodes, including a plurality of first-team offensive instrument nodes and a plurality of second-team defensive instrument nodes;
arranging a plurality of deployment nodes, including a plurality of first-team deployment nodes and a plurality of second-team deployment nodes, wherein a first-team deployment node is configured to represent deployment of a first-team offensive instrument to a first-team offensive instrument site; and a second-team deployment node is configured to represent deployment of a second-team defensive instrument to a second-team defensive instrument site; and
providing a plurality of engagement nodes, wherein:
a relationship from a first-team offensive instrument site node to a first-team deployment node or from a second-team defensive instrument site node to a second-team deployment node is configured as “HOST”; a relationship from a first-team offensive instrument node to the first-team deployment node or from a second-team defensive instrument node to the second-team deployment node is configured as “JOIN”; a relationship from a second-team asset node to an engagement node is configured as “TARGET”; a relationship from the second-team deployment node to the engagement node is configured as “DEFEND”; a relationship from the first-team deployment node to the engagement node is configured as “OFFEND”; and the dynamic knowledge graph is configured for modeling and analysis of behaviors and interactions of opposing teams including the first team and the second team.
